(19) United States
(12) Patent Application Publication
(10) Pub. No.: US 2025/0103371 A1
(43) Pub. Date: Mar. 27, 2025

(54) SYSTEMS AND METHODS FOR IMPLEMENTING FINE-GRAIN SINGLE ROOT INPUT/OUTPUT (I/O) VIRTUALIZATION (SR-IOV)

(71) Applicants: Advanced Micro Devices, Inc., Santa Clara, CA (US); ATI Technologies ULC, Markham (CA)

(72) Inventors: JinYun Liu, Shanghai (CN); Yinan Jiang, Markham (CA); HaiJun Chang, Shanghai (CN)

(73) Assignees: Advanced Micro Devices, Inc., Santa Clara, CA (US); ATI Technologies ULC, Markham (CA)

(21) Appl. No.: 18/472,924

(22) Filed: Sep. 22, 2023

(51) Int. Cl. G06F 9/455

(52) U.S. Cl. CPC G06F 9/45558; G06F 9/45545; G06F 2009/45583

(57) ABSTRACT

The disclosed computing device can include host circuitry configured to provide a physical function and guest circuitry configured to provide a virtual function. The host circuitry is configured to dynamically assign request identifiers for accessing at least the host circuitry in a manner that allows the request identifiers to change on a command-to-command basis instead of a time-to-time basis that uses fixed value request identifiers in time slices. Various other methods, systems, and computer-readable media are also disclosed.

### BACKGROUND

The Single Root Input/Output (I/O) Virtualization (SR-IOV) interface is an extension to the Peripheral Card Interconnect Express (PCIe) specification. SR-IOV allows a computing device, such as a Graphic Processing Unit (GPU) adapter, to separate access to its resources among various PCIe hardware functions. These functions include a PCIe Physical Function (PF) and one or more PCIe Virtual Functions (VFs). The PF is the primary function of the computing device and advertises the computing device's SR-IOV capabilities. The PF is also associated with a hypervisor parent partition in a virtualized environment. Each VF is associated with the computing device's PF. A VF shares one or more physical resources of the computing device, such as memory and one or more engines (e.g., a compute engine and/or a Direct Memory Access (DMA) engine), with the PF and other VFs on the computing device. Each VF is associated with a hypervisor child partition in a virtualized environment.

Each PF and VF is assigned a unique PCI Express Request ID (RID) that allows an I/O memory management unit (IOMMU) to differentiate between different traffic streams and apply memory and interrupt translations between the PF and VFs. This RID allows traffic streams to be delivered directly to the appropriate hypervisor parent or child partition. As a result, nonprivileged data traffic flows to the PF or VF without affecting other VFs.

SR-IOV enables data traffic to bypass the software switch layer of the hypervisor virtualization stack. Because the VF is assigned to a child partition, the data traffic flows directly between the VF and child partition. As a result, the I/O overhead in the software emulation layer is diminished and achieves data flow performance that is nearly the same performance as in nonvirtualized environments.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for implementing fine-grain SR-IOV.

FIG. 2 is a block diagram of an additional example system for implementing fine-grain SR-IOV.

FIG. 3 is a flow diagram of an example method for implementing fine-grain SR-IOV.

FIG. 4 is a graphical illustration of example idle, save, load, and run operations carried out during a virtualization context switch performed with conventional time-sharing SR-IOV.

FIG. 5 is a block diagram of an example system including virtual and physical ring buffers for implementing fine-grain SR-IOV.

FIG. 6 is a graphical illustration comparing workload ratios of conventional time-sharing SR-IOV and fine-grain SR-IOV.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to systems and methods for implementing fine-grain SR-IOV. As will be explained in greater detail below, by configuring host circuitry to provide a physical function, configuring guest circuitry to provide a virtual function, and configuring the host circuitry to dynamically assign request identifiers for accessing at least the host circuitry in a manner that allows the request identifiers to change on a command-to-command basis, the disclosed systems and methods can avoid the need to perform a virtualization context switch. The dynamic assignment of request identifiers on a command-to-command basis instead of a time-to-time basis avoids using fixed value request identifiers in time slices, thus eliminating costly idle/save/load/run procedures required for a virtualization context switch. Removing this performance penalty achieves improved latency that results in improved workload ratios and provides more flexible scheduling capabilities that result in improved workload management.

In one example, a computing device can include host circuitry configured to provide a physical function, and guest circuitry configured to provide a virtual function, wherein the host circuitry is configured to dynamically assign request identifiers for accessing at least the host circuitry in a manner that allows the request identifiers to change on a command-to-command basis instead of a time-to-time basis that uses fixed value request identifiers in time slices.

Another example can be the previously described computing device, wherein the host circuitry is configured to dynamically assign the request identifiers in a manner that routes traffic transmitted by the guest circuitry directly to another virtual function.

Another example can be the computing device of any of the previously described computing devices, wherein the host circuitry is configured to dynamically assign the request identifiers when performing direct memory access for guest circuitry.

Another example can be the computing device of any of the previously described computing devices, wherein the host circuitry is configured to dynamically assign the request identifiers when transmitting interrupts.

Another example can be the computing device of any of the previously described computing devices, wherein the host circuitry is configured to process a ring buffer providing an indication of an access location for a command in an indirect buffer and a context for the command, and the indication of the access location includes a request identifier of the virtual function.

Another example can be the computing device of any of the previously described computing devices, wherein a derivative of the command in the indirect buffer is tagged with a request identifier of the virtual function.

Another example can be the computing device of any of the previously described computing devices, wherein the host circuitry is configured to dynamically assign a request identifier of the virtual function to an interrupt.

Another example can be the computing device of any of the previously described computing devices, wherein the guest circuitry is configured to respond to receipt of the interrupt from the virtual function by writing a sequential number to a memory location according to a request identifier of the virtual function.

Another example can be the computing device of any of the previously described computing devices, wherein the virtual function is configured to submit one or more indirect buffers to a virtual ring buffer that is exposed to a single root input/output virtualization scheduler associated with the physical function.

Another example can be the computing device of any of the previously described computing devices, wherein the single root input/output virtualization scheduler is configured to employ a quality-of-service mechanism to populate a physical ring buffer of the host circuitry with one or more jobs based on the one or more indirect buffers from the guest circuitry.

In one example, a system can include at least one physical processor and physical memory comprising computer-executable instructions that, when executed by the physical processor, cause the physical processor to configure host circuitry to provide a physical function, configure guest circuitry to provide a virtual function, and configure the host circuitry to dynamically assign request identifiers for accessing at least the host circuitry in a manner that allows the request identifiers to change on a command-to-command basis instead of a time-to-time basis that uses fixed value request identifiers in time slices.

Another example can be the system of the previously described example system, wherein the host circuitry is configured to dynamically assign the request identifiers in a manner that routes traffic transmitted by the guest circuitry directly to another virtual function.

Another example can be the system of any of the previously described example systems, wherein the host circuitry is configured to dynamically assign the request identifiers when performing direct memory access.

Another example can be the system of any of the previously described example systems, wherein the host circuitry is configured to dynamically assign the request identifiers when transmitting interrupts.

Another example can be the system of any of the previously described example systems, wherein the host circuitry is configured to process a ring buffer providing an indication of an access location for a command in an indirect buffer and a context for the command, and the indication of the access location includes a request identifier of the physical function, and a derivative of the command in the indirect buffer is tagged with a request identifier of the virtual function.

Another example can be the system of any of the previously described example systems, wherein the host circuitry is configured to dynamically assign a request identifier of the physical function to an interrupt, and the guest circuitry is configured to respond to receipt of the interrupt from the virtual function by writing a sequential number to a memory location according to a request identifier of the virtual function.

Another example can be the system of any of the previously described example systems, wherein the virtual function is configured to submit one or more indirect buffers to a virtual ring buffer that is exposed to a single root input/output virtualization scheduler associated with the physical function, and the single root input/output virtualization scheduler is configured to employ a quality-of-service mechanism to populate a physical ring buffer of the host circuitry with one or more jobs based on the one or more indirect buffers from the guest circuitry.

In one example, a computer-implemented method can include configuring, by at least one processor, host circuitry to provide a physical function, configuring, by the at least one processor, guest circuitry to provide a virtual function, and configuring, by the at least one processor, the host circuitry to dynamically assign request identifiers for accessing at least the host circuitry in a manner that allows the request identifiers to change on a command-to-command basis instead of a time-to-time basis that uses fixed value request identifiers in time slices

Another example can be the method of the previously described example method, wherein the host circuitry is configured to dynamically assign the request identifiers when performing direct memory access.

Another example can be the method of any of the previously described example methods, wherein the host circuitry is configured to dynamically assign the request identifiers when transmitting interrupts.

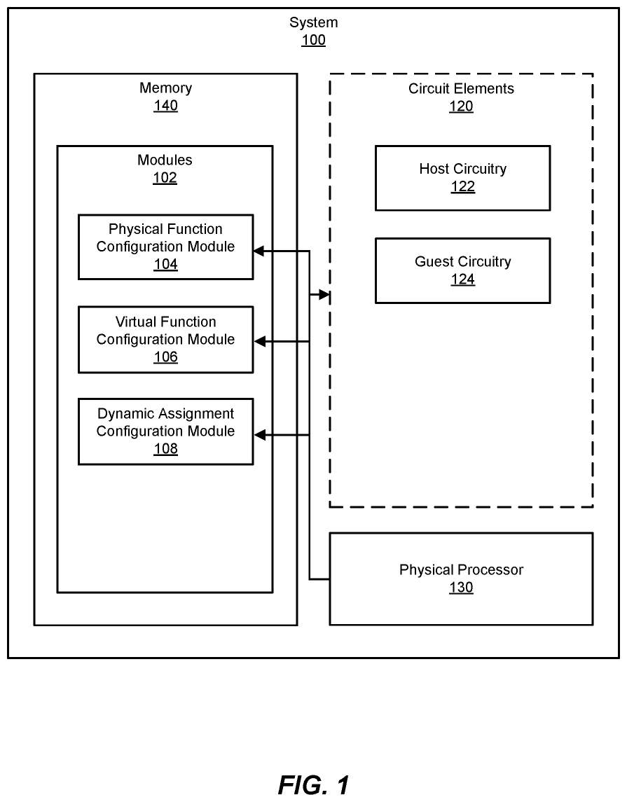

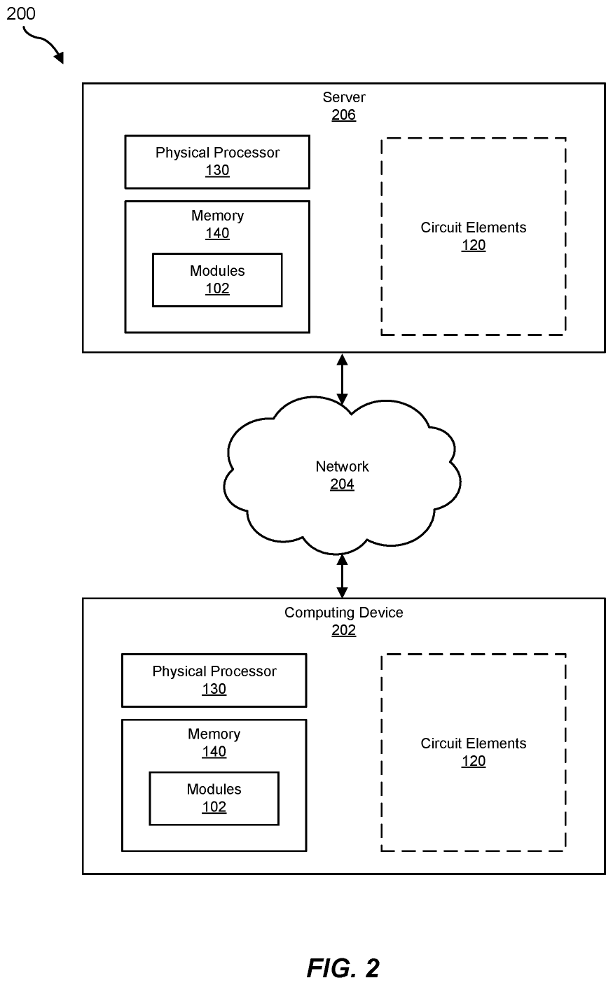

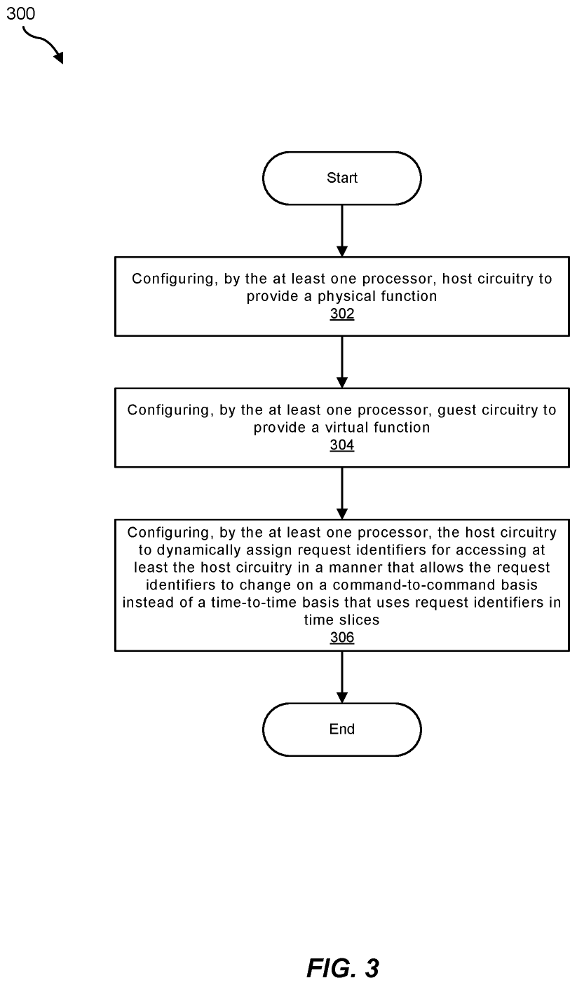

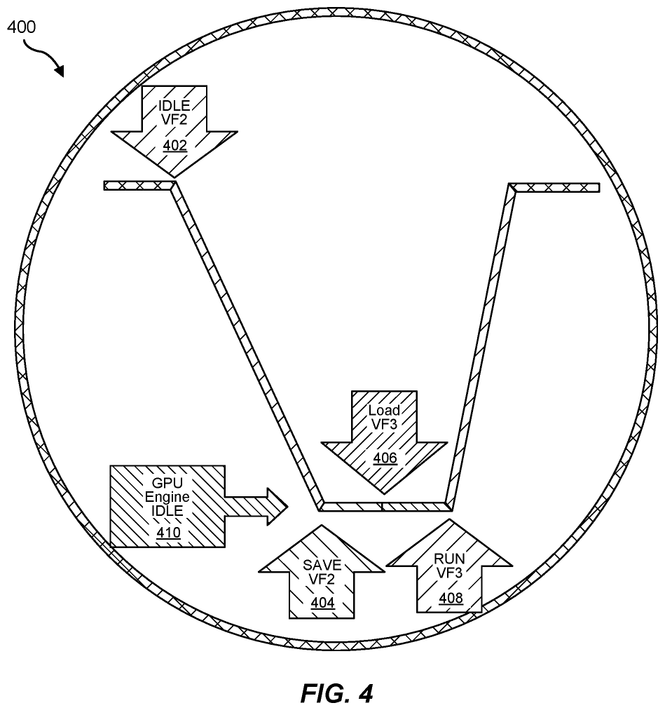

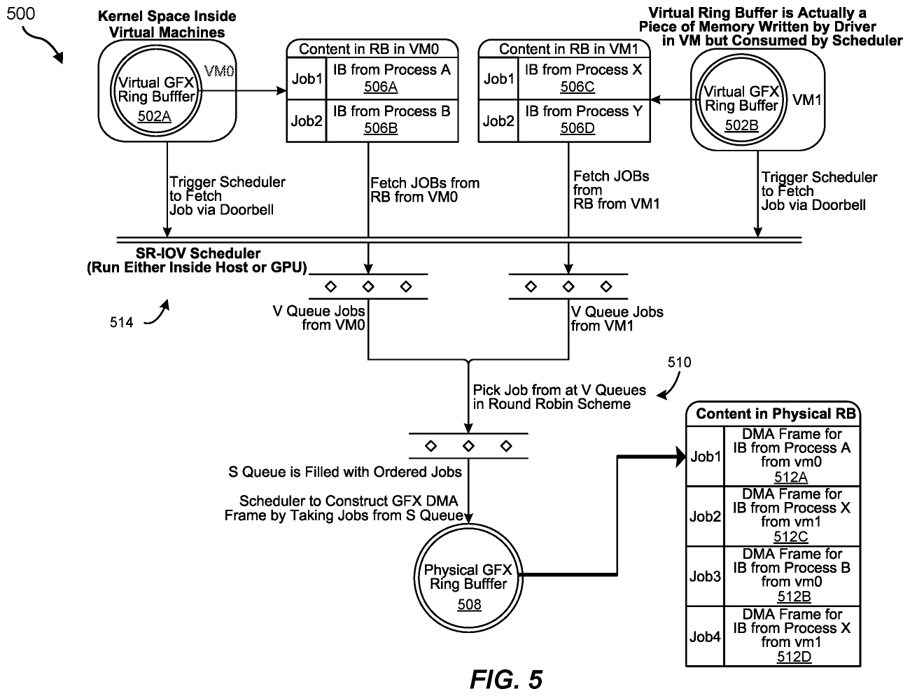

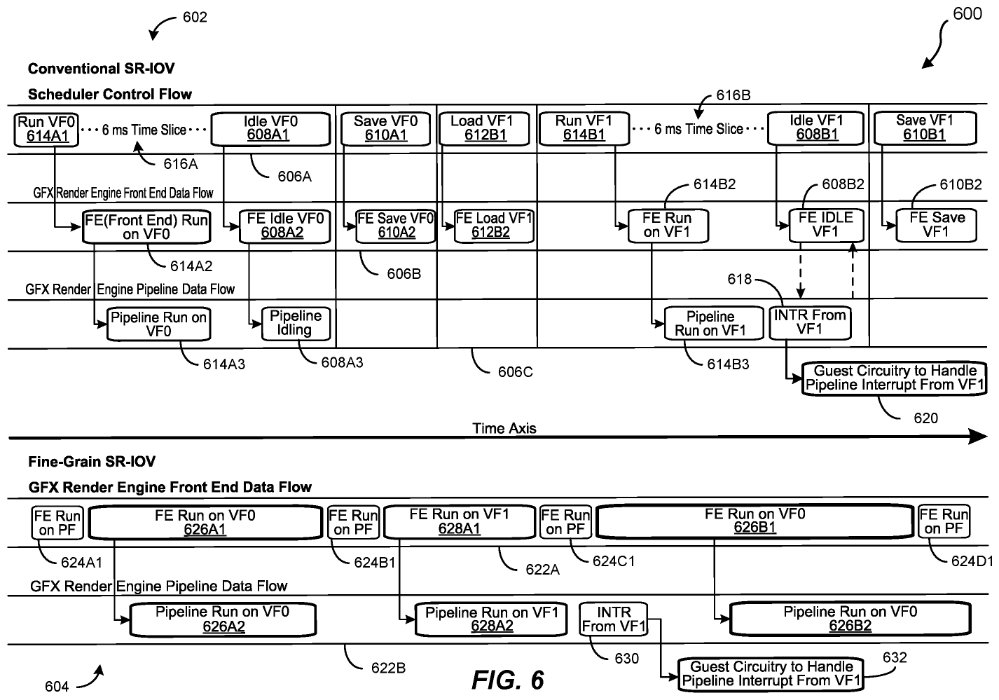

The following will provide, with reference to FIGS. 1-2, detailed descriptions of example systems for implementing fine-grain SR-IOV. Detailed descriptions of corresponding computer-implemented methods will also be provided in connection with FIG. 3. In addition, detailed descriptions of example idle, save, load, and run operations carried out during a virtualization context switch performed with conventional time-sharing SR-IOV will be provided with reference to FIG. 4. Also, detailed descriptions of example systems including virtual and physical ring (e.g., circular) buffers for implementing fine-grain SR-IOV will be described with reference to FIG. 5. Further, detailed descriptions of example workload ratios of conventional time-sharing SR-IOV and fine-grain SR-IOV will be described with reference to FIG. 6.

FIG. 1 is a block diagram of an example system 100 for implementing fine-grain SR-IOV. As illustrated in this figure, example system 100 can include one or more modules 102 for performing one or more tasks. As will be explained in greater detail below, modules 102 can include a physical function configuration module 104, a virtual function configuration module 106, and a dynamic assignment configuration module 108. Although illustrated as separate elements, one or more of modules 102 in FIG. 1 can represent portions of a single module or application.

In certain implementations, one or more of modules 102 in FIG. 1 can represent one or more software applications or programs that, when executed by a computing device, can cause the computing device to perform one or more tasks. For example, and as will be described in greater detail below, one or more of modules 102 can represent modules stored and configured to run on one or more computing devices, such as the devices illustrated in FIG. 2 (e.g., computing device 202 and/or server 206). One or more of modules 102 in FIG. 1 can also represent all or portions of one or more special-purpose computers configured to perform one or more tasks.

As illustrated in FIG. 1, example system 100 can also include one or more memory devices, such as memory 140. Memory 140 generally represents any type or form of volatile or non-volatile storage device or medium capable of storing data and/or computer-readable instructions. In one example, memory 140 can store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 1, example system 100 can also include one or more physical processors, such as physical processor 130. Physical processor 130 generally represents any type or form of hardware-implemented processing unit capable of interpreting and/or executing computer-readable instructions. In one example, physical processor 130 can access and/or modify one or more of modules 102 stored in memory 140. Additionally or alternatively, physical processor 130 can execute one or more of modules 102 to facilitate implementation of fine-grain SR-IOV. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As illustrated in FIG. 1, example system 100 can also include one or more circuits, such as circuit elements 120. Circuit elements 120 generally represent any type or form of circuit board or integrated circuit. In one example, circuit elements 120 can be chiplet processors connected by a switch fabric. Examples of circuit elements 120 include, without limitation, host circuitry 122 and guest circuitry 124.

Example system 100 in FIG. 1 can be implemented in a variety of ways. For example, all or a portion of example system 100 can represent portions of example system 200 in FIG. 2. As shown in FIG. 2, system 200 can include a computing device 202 in communication with a server 206 via a network 204. In one example, all or a portion of the functionality of modules 102 can be performed by computing device 202, server 206, and/or any other suitable computing system. As will be described in greater detail below, one or more of modules 102 from FIG. 1 can, when executed by at least one processor of computing device 202 and/or server 206, enable computing device 202 and/or server 206 to implement fine-grain SR-IOV.

Computing device 202 generally represents any type or form of computing device capable of reading computer-executable instructions. In some implementations, computing device 202 can be and/or include a general-purpose processor and/or graphics processing unit (GPU). Additional examples of computing device 202 include, without limitation, graphics accelerators, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device.

Server 206 generally represents any type or form of computing device that is capable of reading computer-executable instructions. In some implementations, server 206 can be and/or include a general-purpose processor and/or graphics processing unit. Additional examples of server 206 include, without limitation, graphics accelerators, cloud gaming servers, storage servers, database servers, application servers, and/or web servers configured to run certain software applications and/or provide various storage, database, and/or web services. Although illustrated as a single entity in FIG. 2, server 206 can include and/or represent a plurality of servers that work and/or operate in conjunction with one another.

Network 204 generally represents any medium or architecture capable of facilitating communication or data transfer. In one example, network 204 can facilitate communication between computing device 202 and server 206. In this example, network 204 can facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to system 100 in FIG. 1 and/or system 200 in FIG. 2. Conversely, all of the components and devices illustrated in FIGS. 1 and 2 need not be present to practice the implementations described and/or illustrated herein. The devices and subsystems referenced above can also be interconnected in different ways from that shown in FIG. 2. Systems 100 and 200 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

FIG. 3 is a flow diagram of an example computer-implemented method 300 for implementing fine-grain SR-IOV. The steps shown in FIG. 3 can be performed by any suitable computer-executable code and/or computing system, including system 100 in FIG. 1, system 200 in FIG. 2, and/or variations or combinations of one or more of the same. In one example, each of the steps shown in FIG. 3 can represent an algorithm whose structure includes and/or is represented by multiple sub-steps, examples of which will be provided in greater detail below.

As illustrated in FIG. 3, at step 302 one or more of the systems described herein can configure host circuitry. For example, physical function configuration module 104 can, as part of computing device 202 in FIG. 2, configure, by at least one processor, host circuitry to provide a physical function.

The term “host circuitry,” as used herein, can generally refer to underlying hardware. For example, and without limitation, host circuitry can refer to the underlying hardware that provides computing resources, such as processing power, memory, disk and network I/O.

The term “physical function,” as used herein, can generally refer to a graphics or GPU adapter. For example, and without limitation, physical function (PF) can refer to a PCI Express (PCIe) function of a graphics or GPU adapter that supports the single root I/O virtualization (SR-IOV) interface. The PF can include the SR-IOV Extended Capability in the PCIe Configuration space. This capability can be used to configure and manage the SR-IOV functionality of the graphics or GPU adapter, such as enabling virtualization and exposing PCIe Virtual Functions (VFs). The PF can be exposed as a physical graphics or GPU adapter in the management operating system of a hypervisor parent partition.

The systems described herein can perform step 302 in a variety of ways. In one example, a physical device driver of a chiplet processor (e.g., graphics processing unit) can enable one or more chiplets of the chiplet processor to provide a physical function and operate in a host OS under a virtualization environment. In some examples, the physical device driver can enable a hardware processing block (e.g., firmware) to provide the physical functions and operate in the host OS under the virtualization environment. In some implementations, an SR-IOV scheduler can operate on the host OS, but other implementations may configure the SR-IOV scheduler to operate on the graphics processing unit.

At step 304 one or more of the systems described herein can configure guest circuitry. For example, virtual function configuration module 106 can, as part of computing device 202 in FIG. 2, configure, by at least one processor, guest circuitry to provide a virtual function.

The term “guest circuitry,” as used herein, can generally refer to underlying hardware. For example, and without limitation, guest circuitry can refer to the underlying hardware that provides a functional hardware (HW) instance to the operating system and application software that is completely separate and independent from the host circuitry.

The term “virtual function,” as used herein, can generally refer to a function on a graphics or GPU adapter. For example, and without limitation, virtual function can refer to a PCI Express (PCIe) Virtual Function (VF) that is a lightweight PCIe function on a graphics or GPU adapter that supports single root I/O virtualization (SR-IOV). The VF can be associated with the PCIe Physical Function (PF) on the graphics or GPU adapter and represent a virtualized instance of the graphics or GPU adapter. Each VF can have its own PCI Configuration space. Each VF can also share one or more physical resources on the graphics or GPU adapter, such as device memory, with the PF and other VFs.

The systems described herein can perform step 304 in a variety of ways. In one example, the physical device driver of the chiplet processor (e.g., graphics processing unit) can enable one or more chiplets of the chiplet processor to provide a virtual function and operate in guest virtual machine under the virtualization environment. In some examples, the physical device driver can enable two or more hardware processing blocks (e.g., firmware) to provide two or more virtual functions and operate in two or more guest virtual machines under the virtualization environment. These virtual functions can be uniquely addressable using a request identifier (RID) and can have their own configuration spaces and capability structures. Types of virtual functions that can be configured in this manner include, without limitation, a graphics (GFX) engine, a compute engine, and a direct memory access (DMA) engine. In a time-sharing methodology, the virtual functions can take turns running on the graphics processing unit as managed by the SR-IOV scheduler.

At step 306 one or more of the systems described herein can configure dynamic assignment of request identifiers. For example, dynamic assignment configuration module 108 can, as part of computing device 202 in FIG. 2, configure, by at least one processor, the host circuitry to dynamically assign request identifiers for accessing at least the host circuitry in a manner that allows the request identifiers to change on a command-to-command basis instead of a time-to-time basis that uses fixed value request identifiers in time slices.

The term “request identifier,” as used herein, can generally refer to a unique identifier assigned to a PF or VF. For example, and without limitation, request identifier can refer to a unique PCI Express Requester ID (RID) that allows an I/O memory management unit (IOMMU) to differentiate between different traffic streams and apply memory and interrupt translations between the PF and VFs. This can allow traffic streams to be delivered directly to the appropriate hypervisor parent or child partition. As a result, nonprivileged data traffic can flow between other system resource and the PF or VFs without affecting other VFs.

The term “command-to-command basis,” as used herein, can generally refer to change per command. For example, and without limitation, command-to-command basis can refer to change per rendering command, access command, interrupt, etc. Command-to-command basis can contrast with time-to-time basis, in which request identifier change is prohibited during a scheduled time slice.

The systems described herein can perform step 306 in a variety of ways. In one example, dynamic assignment configuration module 108, as part of computing device 202 in FIG. 2, can configure the host circuitry to dynamically assign the request identifiers in a manner that routes traffic transmitted by the guest circuitry directly to another virtual function. In another example, dynamic assignment configuration module 108, as part of computing device 202 in FIG. 2, can configure the host circuitry to dynamically assign the request identifiers when performing direct memory access. In another example, dynamic assignment configuration module 108, as part of computing device 202 in FIG. 2, can configure the host circuitry to dynamically assign the request identifiers when transmitting interrupts. In another example, dynamic assignment configuration module 108, as part of computing device 202 in FIG. 2, can configure the host circuitry to process a ring buffer providing an indication of an access location for a command in an indirect buffer and a context for the command, and the indication of the access location can include a request identifier of the physical function. In some of these examples, a derivative of the command in the indirect buffer can be tagged with a request identifier of the virtual function. In another example, dynamic assignment configuration module 108, as part of computing device 202 in FIG. 2, can configure the host circuitry to dynamically assign a request identifier of the physical function to an interrupt. In some of these examples, the guest circuitry can be configured to respond to receipt of the interrupt from the virtual function by writing a sequential number to a memory location that is within the scope of the guest circuitry. In another example, dynamic assignment configuration module 108, as part of computing device 202 in FIG. 2, can configure the guest circuitry with a virtual function having a GPU driver running in the guest virtual machine that submits indirect buffer to a virtual ring buffer that is exposed to a hypervisor associated with the physical function. In some of these examples, the SR-IOV scheduler can be configured to employ a quality-of-service mechanism to populate a physical ring buffer of the host circuitry with jobs based on the indirect buffers.

As noted above, switching the GPU resource from a first virtual machine (VM1) to a second virtual machine (VM2) is termed a “virtualization context switch” from a first virtual function (VF1) to a second virtual function (VF2). During this procedure, all graphics (GFX) engine related registers, as well as other engine execution environment setting registers, are saved and restored. Meanwhile, various engines (e.g., GFX engine, compute engine, direct memory access (DMA) engine, etc.) all need to be idling with queues being in an unmapped state during idling and saving activity.

Referring to FIG. 4, the activities carried out during a virtualization context switch form a sequence 400 of idle 402, save 404, load 406, and run 408 operations. In some implementations, this sequence 400 can be carried out for all of the virtual functions sequentially, bringing the GPU engine to an idle state 410. Together, these activities cost potentially ≥300 microseconds during a virtualization context switch.

In an example, various steps can be initiated by internal firmware (i.e., hardware processing blocks) that are minor operating systems operating within hardware blocks. For example, idle commands can be sent to the various engines. Accordingly, a graphics render engine can perform preemption to cause the graphics render engine to stall in the middle of a command buffer. Additionally, other engines (e.g., compute engines) can unmap all queues by saving contexts to particular locations (e.g., variables that describe the queues) and preempting execution of compute shader program for any enabled queues. Once all of the engines are idling, the GPU can save numerous GPU engine related registers to a context saving area (e.g., VRAM). Next, the GPU can reset the various engines (e.g., GFX engine, compute engine, direct memory access engine, etc.) to a clear state that is ready to resume the engine execution for the next virtual function. Finally, the GPU can load and run a context for a next virtualization and resume, for example, execution of preempted commands. Consequently, the SR-IOV scheduler can perform numerous handshakes between internal firmware.

The disclosed techniques can avoid the need to perform a virtualization context switch at all, allowing a virtual function to switch its engines (e.g., GFX engines, compute engines, DMA engines) from VM1 to VM2 in a manner that is similar to a process switch. The disclosed techniques can achieve this capability while still securing the direct memory access (DMA) isolation and interrupt routines in the same manner as in conventional time-sharing SR-IOV.

The following implementation provides an example application of the disclosed techniques on the GFX engine, and these techniques can be applied to other engines in a same or similar manner. For example, when the GFX engine is performing DMA access, the “request ID” is no longer a fixed value as in conventional time-sharing SR-IOV (i.e., does not come from a fixed source such as a register or a device memory location). Instead, the “request ID” can be dynamically provided by the engine, which fetches the request ID from its command stream, when performing DMA accesses, triggering interrupts, or performing other actions that utilize the request ID. As a result, the request ID can be changed from command-to-command, resulting in greater flexibility and efficiency by departing from the conventional time slice approach that was required in order to utilize a fixed request ID. Additionally, when the GFX engine is processing the ring buffer that tells the GFX engine where to fetch commands from an indirect buffer provided by a process (e.g., a virtual machine's process) and the context (e.g., which virtual function) for the command, the peripheral component interconnect express (PCIe) read/write packages can be tagged with the physical function's (PF's) request identifier. Also, when the GFX engine is processing commands from the indirect buffer, the derivative PCIe read/write packages can be tagged with the request identifier from the parameters of the indirect buffer command packages. Further, the GFX engine can process end of pipeline commands (e.g., interrupt to the operating system) that can be used to notify the GFX driver when the GFX engine finishes a rendering pipeline. In this case, along with the optional interrupt, there is a corresponding fence (e.g., sequential number) that can be written to a location according to the VF's request identifier, and the optional interrupt can be routine to the virtual machine along with the VF's request identifier. Similarly, interrupts can be routed to a host OS or hypervisor by tagging them with the PF's request identifier.

Referring to FIG. 5, an example system 500 implementing the disclosed techniques can involve employment of one or more virtual ring buffers 502A and 502B at one or more virtual machines VM0 and VM1. These virtual ring buffers 502A and 502B can run inside of kernel space in the virtual machines VM0 and VM1. A virtual ring buffer 502A and/or 502B can be a piece of memory written by the driver in the VM in which it runs, but be consumed by a scheduler, such as SR-IOV scheduler 514 running in the host or GPU. The GPU driver running on the guest VM can submit indirect buffers (IBs) 506A-506D to virtual ring buffers 502A and 502B accordingly, and those IBs 506A-506D can be scheduled to a physical ring buffer 508 that is managed by a PF driver. The virtual ring buffers 502A and 502B can be exposed to the PF driver, which can use, for example, a quality-of-service mechanism 510 (e.g., round robin technique) to populate the IBs into the PF driver's physical ring buffer 508 as jobs 512A-512D corresponding to one or more of the IBs 506A-506D. In an example, a quality-of-service mechanism 510 using a round robin technique can populate the jobs 512A-512D in an order corresponding to a job 512A for a DMA frame for IB from a first process from VM0, a job 512C for a DMA frame for IB from a second process from VM1, a job 512B for a DMA frame for IB from the first process from VM0, and a job 512D for a DMA frame for IB from the second process from VM1. The SR-IOV scheduler 514 can notify the GPU to fetch a job, e.g. 512A-512D, whenever the SR-IOV scheduler 514 populates a job 512A-512D in the physical ring buffer 508.

Referring to FIG. 6, the request identifier can represent how a GPU engine handles the DMA access commands. FIG. 6 provides a comparison 600 between conventional time-sharing SR-IOV 602 and fine-grained SR-IOV 604 from the GFX pipe's perspective. In this example, conventional time-sharing SR-IOV 602 performs a virtualization context switch using a scheduler control flow 606A to send idle commands 608A1 and 608B1, save commands 610A1 and 610B1, load commands 612B1, and run commands 614A1 and 614B1 to the GFX engine while scheduling six millisecond time slices 616A and 616B. In turn, GFX render engine front end data flow 606B receives and responds to those commands. For example, the GFX front end responds to run command 614A1 for VF0 by running on VF0 at 614A2 in time slice 616A. Additionally, the GFX front end responds to idle command 608A1 for VF0 by ramping down to idle on VF0 at 608A2 and responds to save command 610A1 by saving context for VF0 at 610A2. Also, the GFX front end responds to load command 612B1 for VF1 by loading context for VF1 at 612B2. Further, the GFX front end responds to run command 614B1 for VF1 by running on VF1 at 614B2 in time slice 616B. Further, the GFX front end responds to idle command 608B1 for VF1 by ramping down to idle on VF1 at 608B2 and responds to save command 610B1 by saving context for VF1 at 610B2. Meanwhile, GFX render engine pipeline data flow 606C responds to the GFX front end running on VF0 at 614A by the pipeline running on VF0 at 614A3 and responds to the GFX front end idling on VF0 at 608A2 by the pipeline also idling at 608A3. Similarly, pipeline data flow 606C responds to the GFX front end running on VF1 at 614B2 by the pipeline running on VF1 at 614B3. Further, pipeline data flow 606C includes an interrupt 618 initiated from the backend (e.g., VF1), but the handling of this interrupt can be carried out by guest circuitry at 620 in parallel with other activities, such as idle and save commands 608B1 and 610B1 of the scheduler control flow 606A and response thereto at 608B2 and 610B2 by the front end data flow 606B.

In another example of comparison 600, fine-grained SR-IOV 604 does not perform a virtualization context switch using a scheduler control flow to send any idle, save, load, and run commands to the GFX engine or schedule any time slices. Accordingly, GFX render engine front end data flow 622A can run on the physical function at 624A1-624D1, run on VF0 at 626A1 and 626B1, and run on VF1 at 628A1, all without the need to process or respond to any idle, save, load, and run commands. Similarly, pipeline data flow 622B responds to the GFX front end running on VF0 at 626A1 and 626B1 by the pipeline running on VF0 at 626A2 and 626B2 and responds to the GFX front end running on VF1 at 628A1 by the pipeline running on VF1 at 628A2. Further, pipeline data flow 622B includes an interrupt 630 initiated from the backend (e.g., VF1), but the handling of this interrupt can be carried out by guest circuitry at 632 in parallel with other activities, such as the front end running on VF0 at 626B1 and the pipeline running on VF0 at 626B2.

As shown by comparison 600, the workload ratio of the GFX ring operating with conventional time-sharing SR-IOV 602 can be quite low due to the IDLE/SAVE/LOAD/RUN operations that are required for each virtualization context switch from one function to another function costing too many clock cycles. In comparison 600, the workload ratio of the GFX ring operating with fine-grained SR-IOV 604 can be much higher because there is no virtualization context switch and, thus, no idle/save/load/run commands to be sent or processed. As a result, handshakes between the GFX engine and other firmware are greatly reduced, resulting in the workloads of the GFX front end and back end both being greatly increased. Additionally, messages, such as DMA accesses and interrupts, can be transmitted by one virtual machine when another virtual machine is accessing the GPU, and the GPU can receive and process these messages without the need to serialize the command processing that consumes clock cycles in a way that detrimentally impacts the workload ratio.

As set forth above, the request identifier of each PCIe access or interrupt no longer operates as a state machine provided by a fixed source setting but can be dynamically changed for each DMA or render command, thus introducing flexible scheduling policies and avoiding GPU engine context save and restore operations for virtualization context switching. As a result, multi-tenancy performance can be improved greatly, and the cloud gaming use case latency can also be reduced vastly since the host knows everything about the GFX and encoding engines' command status and the host can let the encoding engine serve the VF that just completed one frame's rendering.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 100 in FIG. 1 can be implemented within a virtual environment. For example, the modules and/or data described herein can reside and/or execute within a virtual machine. As used herein, the term “virtual machine” generally refers to any operating system environment that is abstracted from computing hardware by a virtual machine manager (e.g., a hypervisor).

In some examples, all or a portion of example system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computing device comprising:
host circuitry configured to provide a physical function; and
guest circuitry configured to provide a virtual function,
wherein the host circuitry is configured to dynamically assign request identifiers for accessing at least the host circuitry in a manner that allows the request identifiers to change on a command-to-command basis instead of a time-to-time basis that uses fixed value request identifiers in time slices.

2. The computing device of claim 1, wherein the host circuitry is configured to dynamically assign the request identifiers in a manner that routes traffic transmitted by the guest circuitry directly to another virtual function.

3. The computing device of claim 1, wherein the host circuitry is configured to dynamically assign the request identifiers when performing direct memory access for guest circuitry.

4. The computing device of claim 1, wherein the host circuitry is configured to dynamically assign the request identifiers when transmitting interrupts.

5. The computing device of claim 1, wherein:
the host circuitry is configured to process a ring buffer providing an indication of an access location for a command in an indirect buffer and a context for the command; and
the indication of the access location includes a request identifier of the virtual function.

6. The computing device of claim 5, wherein a derivative of the command in the indirect buffer is tagged with a request identifier of the virtual function.

7. The computing device of claim 1, wherein the host circuitry is configured to dynamically assign a request identifier of the virtual function to an interrupt.

8. The computing device of claim 7, wherein the guest circuitry is configured to respond to receipt of the interrupt from the virtual function by writing a sequential number to a memory location according to a request identifier of the virtual function.

9. The computing device of claim 1, wherein the virtual function is configured to submit one or more indirect buffers to a virtual ring buffer that is exposed to a single root input/output virtualization scheduler associated with the physical function.

10. The computing device of claim 9, wherein the single root input/output virtualization scheduler is configured to employ a quality-of-service mechanism to populate a physical ring buffer of the host circuitry with one or more jobs based on the one or more indirect buffers from the guest circuitry.

11. A system comprising:
at least one physical processor; and
physical memory comprising computer-executable instructions that, when executed by the at least one physical processor, cause the at least one physical processor to:
configure host circuitry to provide a physical function;
configure guest circuitry to provide a virtual function; and
configure the host circuitry to dynamically assign request identifiers for accessing at least the host circuitry in a manner that allows the request identifiers to change on a command-to-command basis instead of a time-to-time basis that uses fixed value request identifiers in time slices.

12. The system of claim 11, wherein the host circuitry is configured to dynamically assign the request identifiers in a manner that routes traffic transmitted by the guest circuitry directly to another virtual function.

13. The system of claim 11, wherein the host circuitry is configured to dynamically assign the request identifiers when performing direct memory access.

14. The system of claim 11, wherein the host circuitry is configured to dynamically assign the request identifiers when transmitting interrupts.

15. The system of claim 11, wherein:
the host circuitry is configured to process a ring buffer providing an indication of an access location for a command in an indirect buffer and a context for the command, and the indication of the access location includes a request identifier of the physical function, and
a derivative of the command in the indirect buffer is tagged with a request identifier of the virtual function.

16. The system of claim 11, wherein:
the host circuitry is configured to dynamically assign a request identifier of the physical function to an interrupt, and
the guest circuitry is configured to respond to receipt of the interrupt from the virtual function by writing a sequential number to a memory location according to a request identifier of the virtual function.

17. The system of claim 11, wherein:
the virtual function is configured to submit one or more indirect buffers to a virtual ring buffer that is exposed to a single root input/output virtualization scheduler associated with the physical function, and
the single root input/output virtualization scheduler is configured to employ a quality-of-service mechanism to populate a physical ring buffer of the host circuitry with one or more jobs based on the one or more indirect buffers from the guest circuitry.

18. A computer-implemented method, at least a portion of the computer-implemented method being performed by a computing device comprising at least one processor, the computer-implemented method comprising:
configuring, by the at least one processor, host circuitry to provide a physical function;
configuring, by the at least one processor, guest circuitry to provide a virtual function; and
configuring, by the at least one processor, the host circuitry to dynamically assign request identifiers for accessing at least the host circuitry in a manner that allows the request identifiers to change on a command-to-command basis instead of a time-to-time basis that uses fixed value request identifiers in time slices.

19. The computer-implemented method of claim 18, wherein the host circuitry is configured to dynamically assign the request identifiers when performing direct memory access.

20. The computer-implemented method of claim 18, wherein the host circuitry is configured to dynamically assign the request identifiers when transmitting interrupts.
